(19) United States
(12) Patent Application Publication
(10) Pub. No.: US 2010/0295484 A1
(43) Pub. Date: Nov. 25, 2010

(54) Lock Light

(76) Inventor: Carson Kelly Smith, Oregon City, OR (US)

Correspondence Address: Davis Wright Tremaine LLP - Portland;William A. Birdwell, 1300 S.W. Fifth Avenue, SUITE 2300, Portland, OR, 97201-5630, US

(21) Appl. No.: 12/772,076

(22) Filed: Apr. 30, 2010

Related U.S. Application Data
(63) Continuation-in-part of application No. 12/012,129, filed on Jan. 30, 2008.

(51) Int. Cl. H05B 37/02; F21L 4/00; E05B 17/10

(52) U.S. Cl. 315/362; 362/191; 362/157; 362/100

(57) ABSTRACT

A battery powered high-intensity illumination device enclosed in a waterproof housing is adapted for removable attachment to a surface adjacent to a lock. Upon removing the device from the surface, one may easily transport it in the palm of one's hand or in a pocket, because of its compact, ergonomic size and shape. Activation of the device may be automatic, triggered by motion detection or a touch-sensitive switch. An internal shutoff timing circuit ensures hands free operation and energy efficiency. Angular adjustment allows the housing to be rotated so as to fixably alter the angle of the light beam with respect to the illumination target. A reflector allows the light source to be shielded from view and for light output to be focused on an area of interest. The size, shape, and appearance of the lock light are appealing and unique features of the device.

### RELATED APPLICATIONS

This patent application is a continuation-in-part (CIP) of U.S. patent application Ser. No. 12/012,129 filed on Jan. 30, 2008, to which the present patent application claims benefit, and which is hereby incorporated by reference in its entirety. This patent application is also related to U.S. Design Patent Application 29/315,077, filed on May 21, 2009.

### BACKGROUND INFORMATION

As a consequence of longer work days, more Americans routinely leave and return to their homes in the dark. Inserting a key into a door lock in the shadows, or fumbling for the correct key can be frustrating and even dangerous. Attempting to insert a key or dial a combination into a padlock in the dark is often a fruitless endeavor. To eliminate these problems, some automotive keys are specially equipped with either a small light-emitting diode (LED) encased in a housing or an electronic remote keyless entry fob. However, such high-tech key fobs are typically expensive and bulky, and they are impractical substitutions for the many different keys used for houses, sheds, storage units, and the like. While miniature lights may be attached to key chains, often their use is impractical. For example, opening a padlock requires one hand to steady the padlock and the other hand to insert the key, which precludes also holding, switching, and directing a separate light. Furthermore, keychain lights are not dedicated to illuminating a specific lock, and their multi-purpose use often results in a depleted battery, causing the light to be unreliable.

Directed lights such as the keyhole illuminator described in U.S. Pat. No. 2,661,417 provide basic functionality, but small incandescent bulbs as disclosed therein produce relatively dim light and consume so much battery power that batteries have to be replaced often. If the bulb and the batteries were made large enough to produce a bright light over a long time period, the device becomes too bulky to be truly portable. As a result, devices like the keyhole illuminator have significant drawbacks.

### SUMMARY

A novel, compact, lock light as disclosed herein may be affixed adjacent to a lock mechanism such as a door lock or a padlock to provide a dependable, attractive light source that offers both safety and convenience. The present invention provides a battery powered, high intensity light source enclosed in a water resistant housing that removably attaches to a base. In turn, the base is adapted for attachment to a surface in close proximity to a lock, using adhesives, magnets, screws, or other similar means. The lock light may utilize a timer delay circuit in combination with a detector to operate the light source, hands free, for a preset time interval. In addition, an adjustable beam angle may be set to properly illuminate the area of interest near a keyhole. A region of illumination at a point of interest (e.g., a keyhole) may be adjusted by changing the mounting position of the lock light relative to the keyhole, by adjusting the orientation of the light source relative to the base, or by directing the light rays using a shield or a reflector, which also serves to shield the bright light source from direct view. The lock light may also be used to illuminate other objects in unlit or darkened environments such as keypads or utility meters. It may be used as a dedicated fixture, or it may be removed, pocketed, and carried from place to place.

It is an object of the present invention to provide a compact, portable light, removably attached to any surface.

It is another object of the present invention to provide a high intensity, directed light, that is touch-activated, energy-efficient, and shuts off automatically.

It is a further object of the present invention to provide a compact, portable light capable of illumination angle and direction adjustment.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements. Other objects, features and aspects of the present invention are discussed in greater detail below.

### BRIEF DESCRIPTION OF THE DRAWINGS

FIG. 1 is a vertical side view of an embodiment of a lock light installed on a door.

FIG. 2 is a front view of the embodiment of a lock light shown in FIG. 1, installed on a padlock.

FIG. 3 is a side view of a lock light, equipped with a light reflector, and installed on a padlock.

FIG. 4 is a horizontal side view of a preferred embodiment of a lock light in which a portion of the housing acts as a light reflector, or shield.

FIG. 5 is a horizontal side view of a preferred embodiment of a lock light equipped with an optional light reflector having a locking tabs mechanism.

FIG. 6 is a horizontal side view of an alternative embodiment of a lock light in which a reflector is molded into the top surface of the housing.

FIG. 7 is a block diagram of a prior art exemplary microcontroller that may be programmed to control the timing or intensity of the light.

FIG. 8 is a plan view of the underside of the embodiment shown in FIG. 6, showing screw holes.

### DETAILED DESCRIPTION

Embodiments of the present invention will be readily understood from the following detailed description in conjunction with the accompanying drawings. To facilitate this description, like reference numerals designate like structural elements. Embodiments of the invention are illustrated by way of example and not by way of limitation in the figures of the accompanying drawings.

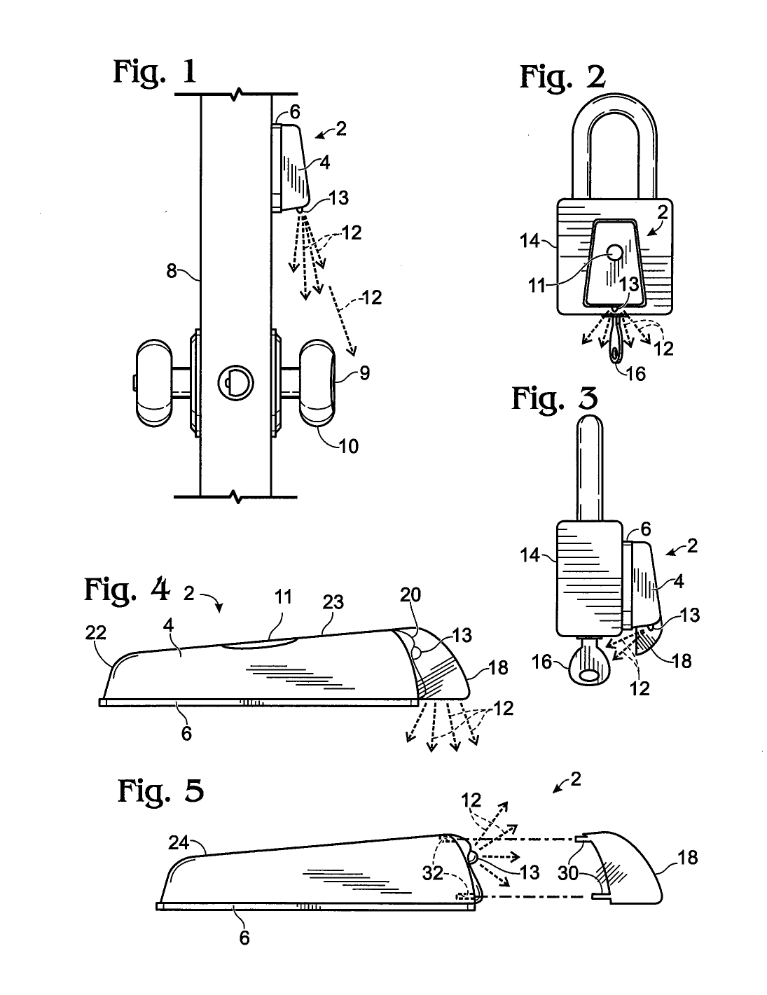

The basic structure and use of a lock light 2 is illustrated in FIGS. 1-3. FIG. 1 shows lock light 2, preferably having a waterproof or water-resistant detachable housing 4 and a detachable base 6, affixed to a door 8. Lock light 2 is preferably removably mounted above, or otherwise adjacent to, a lock 9 shown in FIG. 1. Detachable base 6 may be, for example, magnetic, adhesive, or attached with screws. Likewise, detachable housing 4 may be affixed to base 6 by magnetic, adhesive, or mechanical means (such as, for example, a locking tabs mechanism, a sliding mechanism, and Velcro® brand hook and loop fasteners), the orientation of housing 4 being preferably rotatable with respect to base 6. Lock 9 may be a key lock, for example, a keyhole embedded within a doorknob 10 as shown, or it may be a separate hardware component such as a key-activated dead bolt lock, an electronic card key lock, a mechanical or electronic combination lock, or the like. (In general, the term “key” used herein refers to any form of a device used to grant access.) When lock light 2 is turned on in response to activation of a switch 11, light rays 12 emanating from a light source 13 are directed toward lock 9 so as to illuminate it, so that a key may be easily inserted into the lock 9. The area of illumination may be changed by adjusting the placement of the lock light detachable base 6, or, in certain embodiments, by rotating housing 4 with respect to base 6, or in certain embodiments, by removing or adjusting a reflector described below. Furthermore, housing 4 is both attractively and functionally shaped. Housing 4 has generally rounded edges, and is sized to fit easily into the palm of a human hand or a pocket so as to be both ergonomic and portable.

An advantage of lock light 2 is that it blends visually with exterior door hardware, and complements the appearance of an entryway. The color and general appearance of housing 4 may be matched to the door, or to door hardware components (e.g., handles, knobs, door knockers, kick plates, and deadbolt locks) to achieve a coordinated look. Housing 4 may be made of plastic, metal, or other waterproof or water-resistant materials that preferably allow a choice of different exterior surface finishes so that the finish may match common door hardware finishes such as, for example, shiny brass, antique brass, nickel, and stainless steel, or colors such as black, white, or brown that match wood or other popular door colors. Alternatively, the surface of housing 4 may be paintable to match any color, or textured to match a finish such as wrought iron. When lock light 2 is mounted on door 8 with a reflector, housing 4 shields light source 13 from direct view, so that an observer sees generally downward-directed light rays 12. This produces a sophisticated, subtle, bounced-lighting effect, without glare, and without calling undue attention to the entryway.

In FIGS. 2 and 3, lock light 2 is shown affixed to a stand-alone lock 14, in this instance, a padlock, so as to illuminate a key 16, while being shielded by an optional reflector 18. Again, stand-alone lock 14 may be opened by means other than a traditional key, for example a combination mechanism or an electronic key. In FIG. 2 the lock light 2 is shown without a reflector 18. When utilized without reflector 18, lock light 2 illuminates the general vicinity of a lock 9 which may make searching for keys easier. In FIG. 3 the lock light 2 is equipped with a reflector 18 adjacent to a light source 13 so as to concentrate and direct light rays 12. Light source 13 preferably comprises one or more low-power, bright lights such as a light-emitting diode (LED), preferably featuring programmably-controlled intensity.

FIG. 4 shows a side view of an embodiment of a lock light 2, attached to door 8 at an attachment point hidden underneath the base 6. Lock light 2 preferably features a smooth housing 4 having a tapered shape, including a lower end surface 20 that may be flat or may curve toward base 6. An aperture is formed in the lower end surface for emission of a light beam. A rounded top surface 23 curves toward the base 6, preferably turning sharply inward at its upper portion 22, and preferably extends downward beyond the lower end surface, thereby shielding the light source to some extent. Reflector 18 serves the dual function of both reflecting light toward the lock and more fully shielding light source 13 from view. The shape of lock light 2 so described presents an ergonomic form factor, to which a human hand may easily conform so as to facilitate removing the lock light and transporting it in the palm of one's hand, or slipping the lock light into a pocket. In FIG. 4, switch 11 is shown as a manual push-button type switch built into, and flush with, the top surface of housing 4.

Reflector 18 may be one of a host of suitable reflective or focusing devices that is capable of altering the concentration, direction, and intensity of a light beam. FIG. 5 shows a side view of a variation of the preferred embodiment of FIG. 4, in which the reflector 18 is a detachable portion of housing 4, such that when reflector 18 is removed, light source 13 is exposed. Reflector 18 may be frictionally fit onto the housing 4 using one or more tabs 30 that engage with one or more recesses 32. However, reflector 18 may be attached to housing 4 by any of a number of other simple, well known, mechanical means.

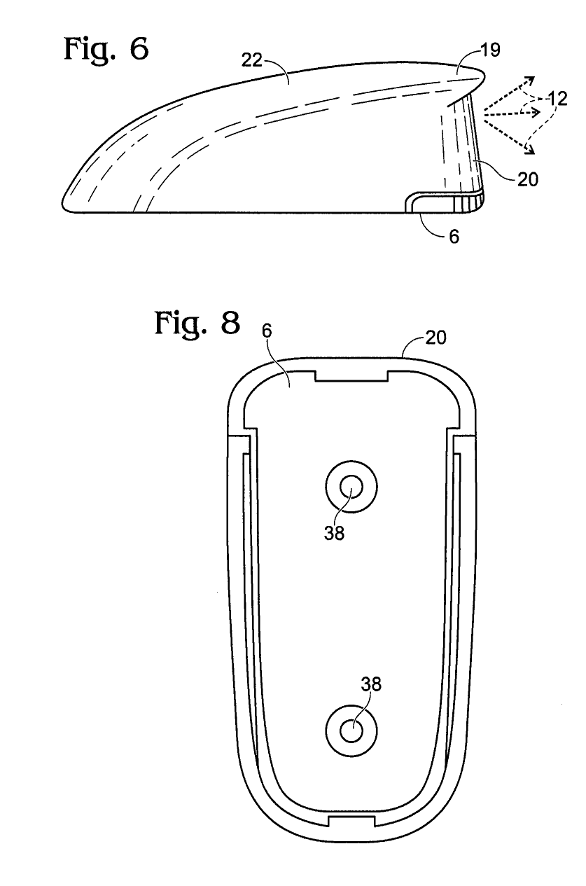

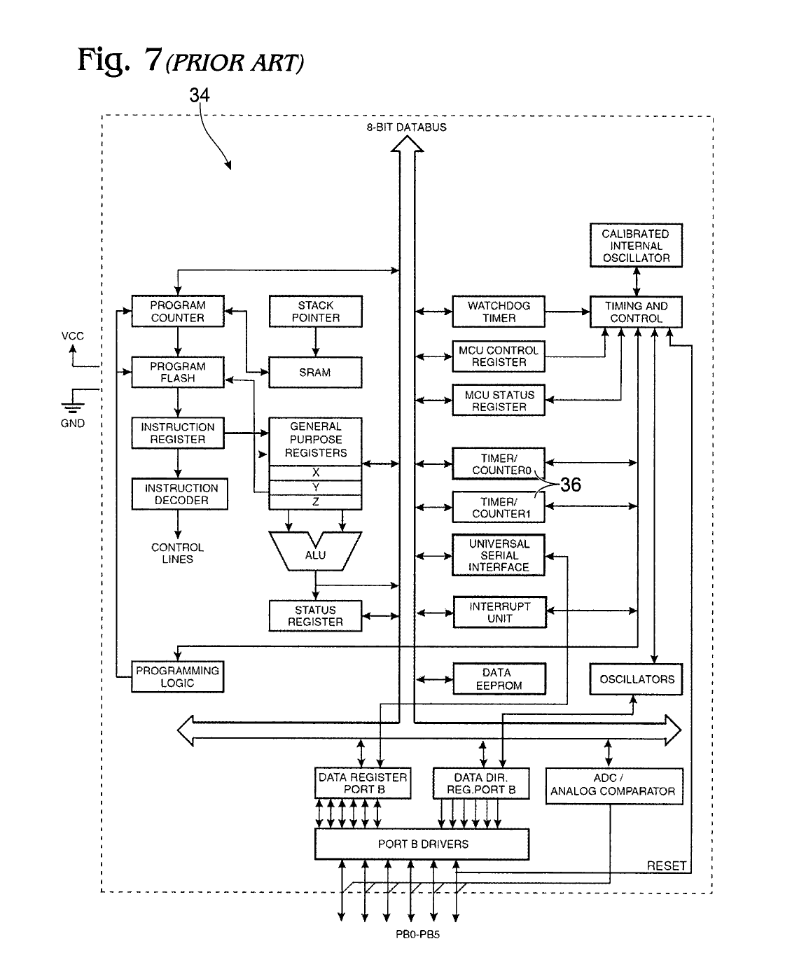

Alternatively, the reflector may simply take the form of a shield or a deflector 19, similar to the bill of a cap, that is molded into rounded top surface 23 of housing 4 itself, as shown in the preferred embodiment of FIG. 6. In such a preferred embodiment, housing 4 is waterproof and contains internal electronic components such as, for example, a circuit board, a programmable timing circuit, a programmable controller circuit, additional resistors, and internal wiring to enable automatic shutoff and brightness control features. Part of housing 4 may serve as a motion-sensitive, sound-sensitive, or touch-sensitive switch that toggles the light source on and off to save energy and to provide further ease of use. In a preferred embodiment, a touch-sensitive switch is used wherein a portion or portions of the housing are touch-sensitive. This feature provides a particular advantage in that it personalizes the light so that, while it can readily be activated by a light touch of the hand of someone who knows what part or parts of the housing are sensitive, an intruder may not discern how to activate the light. Touch sensors also help to ensure that the light stays off when it is not needed, whereas motion sensors may be accidentally triggered by extraneous moving objects, like branches or small animals. Further, in contrast to motion or light sensors, for example, a touch sensor facilitates use of the light with recreational vehicles. Once the lock light switch is activated, if it is not switched off within a predetermined, preferably programmable, time interval, it may shut off automatically. Automatic shutoff may be controlled by an electronic countdown timer, for example, one that is based on a low power, programmable microcontroller chip such as the “ATTiny” available from Atmel, Inc., of San Jose, California, or a similar device. A block diagram of such an existing timer circuit is provided in FIG. 6, which includes a programmable 8-bit microprocessor 34 and multiple timers 36. Housing 4 contains a power source, preferably, lithium batteries, which are corrosion resistant, long-lasting and recyclable, and allow the light to perform throughout a wide temperature range of at least about −20 degrees C. to about +40 degrees C.

In an operational scenario, a user may simply contact the lock light housing 4, insert a key into the lock 9, and enter the premises. Lock light 2 then shuts off automatically after, for example, 10 seconds. Upon leaving, the user may wish to detach lock light 2, use it as a mini-flashlight to illuminate a corner of a garden, a garage, a shed, or a mailbox, or slip it into a pocket while going for a walk, and then re-attach lock light 2 to door 8 upon re-entering. Lock light 2 is thus attractive, handy, portable and versatile. Furthermore, low-power, high-intensity LEDs and automatic shutoff features make the lock light 2 energy-efficient and wireless, eliminating a need for permanent installation. Detaching lock light 2 may entail detaching lock light 2 from base 6, for example, if base 6 is secured to door 8 with an adhesive or with screws as shown in FIG. 8; or detaching lock light 2 may entail detaching base 6 as well, if base 6 is secured to door 8 magnetically.

Although certain embodiments have been illustrated and described herein, it will be appreciated by those of ordinary skill in the art that a wide variety of alternative or equivalent embodiments or implementations calculated to achieve the same purposes may be substituted for the embodiments illustrated and described without departing from the scope of the present invention. Those with skill in the art will readily appreciate that embodiments in accordance with the present invention may be implemented in a very wide variety of ways. This application is intended to cover any adaptations or variations of the embodiments discussed herein.

The terms and expressions which have been employed in the foregoing specification are used therein as terms of description and not of limitation, and there is no intention, in the use of such terms and expressions, to exclude equivalents of the features shown and described or portions thereof, it being recognized that the scope of the invention is defined and limited only by the claims that follow.

1. A portable light comprising:
a battery-powered high-intensity light source that produces a light beam;
a touch-sensitive switch for activating the light source;
a base for removably attaching the light to a surface at an attachment point located underneath the base; and
a housing, having tapered vertical sides, a flat lower end surface in which an aperture is formed for emission of the light beam, and a rounded top surface that curves upward toward the base and extends downward beyond the lower end surface, thereby shielding the light source, hiding the attachment point, and presenting an ergonomic size and shape to which a human hand may easily conform.

2. The light of claim 1, wherein the housing is shaped so as to alter the concentration, direction, and intensity of the light beam.

3. The light of claim 2, wherein the housing is rotatably connected to the base so as to alter the direction of the light beam.

4. The light of claim 2, wherein a portion of the housing comprises a reflector that alters the direction of the light beam.

5. The light of claim 1, further comprising a magnet for attaching the base to the surface.

6. The light of claim 1, further comprising an adhesive for attaching the base to the surface.

7. The light of claim 1, further comprising screw holes disposed in the base for attaching the base to a surface using screws.

8. The light of claim 1, further comprising a timer that shuts off the light source after a prescribed time interval has elapsed.

9. The light of claim 8, wherein the timer is disposed within the housing, and the timer comprises an electronic timing circuit.

10. The light of claim 8, wherein the prescribed time interval is programmable.

11. The light of claim 1, wherein the housing comprises a paintable plastic.

12. The light of claim 1, wherein the high intensity light source is a light emitting diode.

13. The light of claim 1, wherein the intensity of the light source is programmably controlled.

14. The light of claim 1, wherein the curved shape of the housing facilitates activation of the touch sensitive switch.

15. The light of claim 1, wherein the battery power is provided by a lithium battery that enables a compact form factor and portability.

16. The light of claim 1, wherein the ergonomic size and shape of the housing enables carrying the lock light in the palm of a human hand or in a pocket.

17. A detachable, portable light, comprising:
a battery-powered high intensity light source that produces a light beam; and
a housing, including a switch activated by contact with the housing, the housing having a protruding reflector to shield the light source and direct laterally propagating light toward an area to be illuminated.

18. The light of claim 17, wherein the high intensity light source is a light emitting diode.

19. The light of claim 17, wherein the intensity of the light source is programmable.

20. The light of claim 17, wherein the housing attaches to a base having a magnet for attaching to a surface.

21. The light of claim 17, wherein the housing attaches to a base having an adhesive for attaching to a surface.

22. The light of claim 17, wherein the housing attaches to a base having screw holes for attaching the base to a surface using screws.

23. The light of claim 17, further comprising a timer that shuts off the light source after a prescribed time interval has elapsed.

24. The light of claim 23, wherein the timer comprises an electronic timing circuit.

25. The light of claim 23, wherein the timer is programmable.

26. The light of claim 17, wherein the housing is shaped so as to alter the concentration, direction, and intensity of the light beam.

27. The light of claim 17, wherein the housing is rotatably connected to a base so as to alter the direction of the light beam.

28. The light of claim 17, wherein the protruding reflector comprises a molded extension of the housing.

29. The light of claim 17, wherein the housing comprises paintable plastic.

30. A method of selectively illuminating a lock, comprising:
providing a high intensity battery-powered light source for emitting a light beam;
providing a switch that may be activated by contact with a detachable housing;
shielding the light source;
attaching the housing to a base mounted adjacent to a lock; and
activating the light beam by contacting the housing.

31. The method of claim 30, further comprising positioning the housing to alter the concentration, direction, and intensity of the light beam.

32. The method of claim 30, further comprising automatically shutting off the light beam using a timer.

33. The method of claim 30, further comprising programming the timer to shut off the light beam after a pre-set time interval.

34. The method of claim 30, further comprising programming the intensity of the light beam.

35. The method of claim 30, wherein providing a high-intensity battery-powered light source facilitates removing the light and carrying it in the palm of a human hand or in a pocket.
